(19) United States
(12) Patent Application Publication
(10) Pub. No.: US 2014/0229588 A1
(43) Pub. Date: Aug. 14, 2014

(54) CONFIGURATION RECOMMENDATION FOR A HOME DEVICE

(71) Applicants: Johan Hjelm, Tokyo (JP); Mattias Lidström, Stockholm (SE); Mona Matti, Nacka (SE)

(72) Inventors: Johan Hjelm, Tokyo (JP); Mattias Lidström, Stockholm (SE); Mona Matti, Nacka (SE)

(73) Assignee: Telefonaktiebolaget L.M. Ericcson(publ), Stockholm (SE)

(21) Appl. No.: 14/345,106

(22) PCT Filed: Dec. 2, 2008
(86) PCT No.: PCT/SE2008/051388

§ 371 Date: Mar. 14, 2014

(51) Int. Cl. H04L 12/24

(52) U.S. Cl. CPC H04L 41/0803
USPC 709/220

(57) ABSTRACT

A method for providing a configuration recommendation to a first home device (201) in a home network, the method comprising the steps of: detecting (101a, 101b), at a multimedia gateway (210), a change in the first home device; sending (102, 103, 105), from the gateway to a home device configuration recommender (223), data indicative of the change; requesting and receiving (104b, 106b), at the home device configuration recommender (223), data representing capabilities of a plurality of home devices; comparing (107) the data representing capabilities with the data indicative of the change, for determining a suitable configuration recommendation for the first home device; and sending (108, 109, 110), from the home device configuration recommender (223) via the multimedia gateway (210) to the first home device (201), data representing the suitable configuration recommendation. A system and computer readable medium is also described.

### TECHNICAL FIELD

The invention relates to a method, system and computer readable medium for providing a configuration recommendation to a home device.

### BACKGROUND ART

Today, several methods and standards are known for monitoring network-attached devices which sometimes include managing of a configuration of home devices with in respect of how these devices use services and features. Some of these methods and standards include the Simple Network Management Protocol (SNMP) that is used in network management systems to monitor network-attached devices for conditions that warrant administrative attention. Another method includes DSL Forum TR-069 which defines an application layer protocol for remote management of end-user devices and the device management protocol specified by the Open Mobile Alliance (OMA) Device Management (DM) Working Group and the Data Synchronization (DS) Working Group.

All these methods and protocols basically work in the same way, i.e. they provide a document of the desired configuration, and possibly software and/or references where software can be found, and allows the home device to configure itself when it is restarted or if a reset occurs. When most of these systems were defined, the assumption was that there would be a primary maintainer through which the system and home devices would be managed (e.g. by an operator).

Some typical home devices, or user equipments, include personal computers, media players, TV's, PDA's, cameras, video cameras, various security systems etc.

However, in managed systems where hardware and software can be installed by several users in addition to a primary maintainer, such as a PC which may be installed and connected to a network by users as well as by a central maintenance system, there is potential for conflicts between different versions of software. Even worse, in a network where several systems competing for the same hardware and/or software resources, there is a risk that these systems will try to use the same, often limited resources at the same time. For instance, a user may wants to play a copyright-protected version of a music file, which file can only be played on one player at the time, i.e. not on his home stereo and on his mobile phone at the same time. There is also a risk for feature interactions between systems and software, trying to set various parameters in a conflicting way.

These problems have not yet been evident in current residential network systems. However, as they are becoming managed and as they start containing multiple entities which potentially use the same resources, this type of conflicts are likely to occur, especially in the case of service blending and content mashups when devices are accessing multiple different resources in an uncontrolled manner.

One way to handle the described problems is to set a proper configuration of user equipments in the system, such that conflicts are avoided or at least reduced. How the configuration per se should be set of course depends on the type of user equipment and on the type of conflict, but a major issue that remains to be solved is the way the configuration settings are provided, which also includes how the underlying system and its communication is structured and handled.

Today there are technologies for providing configuration settings for various types of user equipments, such as the method and system described in WO-2005/006304, where electronic component connectivity configurations and marketing information of certain electronic equipment are recommended to a user based upon information received from the user. The method includes: providing a user interface display containing data representing a group of predetermined user-selectable electronic components; receiving data representing a user-selected subset of electronic components from the group of predetermined user-selectable electronic components; retrieving from a database attributes associated with each component of the subset of electronic components; comparing the subset of electronic components with the associated attributes to determine an appropriate component configuration; and presenting data representing the electronic component configuration to the user.

Further background art is reflected by EP-1091522 and US-2004/131042.

However, even though techniques of today provide configuration settings, the systems and methods used are quite complex and tend to be hard to implement, or they rely on manual input or communication between various components of the system.

### SUMMARY

In view of the foregoing, it is an object of the invention to provide an improvement of the above techniques and prior art. More particularly, it is an object to provide an easily implementable method and system for providing configuration recommendations.

Hence a method is disclosed for providing a configuration recommendation to a first home device of a plurality of home devices in a home network, the method comprising the steps of: detecting, at a multimedia gateway connected to the home devices, a change in the first home device; sending, from the gateway to a home device configuration recommender, data indicative of the change; requesting and receiving, at the home device configuration recommender and from a home device capability database, data representing capabilities of the home devices; comparing, at the home device configuration recommender, the data representing capabilities with the data indicative of the change, for determining a suitable configuration recommendation for the first home device; and sending, from the home device configuration recommender via the multimedia gateway to the first home device, data representing the suitable configuration recommendation.

The inventive method is advantageous in that communicating and operating steps are performed in a mutually efficient way, and in that it is rather straightforward to implement the method both when designing new systems but also when implementing the method in already existing systems. Here, a “device” is a physical device and the change maybe, for example, a software upgrade in the device, a change of a setting in the device, or connection or de-connection of the device to the gateway. The device may also be a virtual device in the form of a software implementation in a physical device.

The step of sending the data indicative of the change may comprise sending this data via a presence agent and a presence server, which speeds up the process of providing a recommendation as well as allows for easy implementation in networks that are used today. Here, an “agent” is a piece of software that is executed on and acts for the gateway.

The step of sending the data indicative of the change may comprise sending this data via a home network application server, which, again, allows efficient and quick implementation of the method.

The method may comprise the step of retrieving, from a database and by the home network application server, data representing capabilities of the home devices, which provides for more convenient configuration recommendation of e.g. home devices that are new on the market, since capabilities of the home device may be centrally distributed via the database that In turn might be connected to several different home networks.

The step of retrieving data representing capabilities of the home devices may be initiated by a request sent from the home device configuration recommender to the home network application server.

The step of sending data representing the suitable configuration recommendation may comprise sending this data via a device management server and a proxy server of the multimedia gateway.

The data indicative of the change and the data indicative of the suitable configuration recommendation may be sent as Session Initiation Protocol (SIP) messages.

The multimedia gateway may be a home IMS gateway and the home network may be an IMS network.

For the inventive method, the data representing capabilities and the data indicative of the change each comprise a formal representation of a set of features of the associated home device, for providing the suitable configuration recommendation based on a performance impact of the change on the capabilities of the home devices.

According to another aspect of the invention, a computer system is described for providing a configuration recommendation to a first home device of a plurality of home devices in a home network. The system is configured to: detect, at a multimedia gateway connected to the home devices, a change in the first home device; send, from the gateway to a home device configuration recommender, data indicative of the change; request and receive, at the home device configuration recommender and from a home device capability database, data representing capabilities of the home devices; compare, at the home device configuration recommender, the data representing capabilities with the data indicative of the change, for determining a suitable configuration recommendation for the first home device; and send, from the home device configuration recommender via the multimedia gateway to the first home device, data representing the suitable configuration recommendation.

According to yet another aspect of the invention, a computer readable medium is provided, having stored thereon a computer program having software instructions which when run in a computer system cause the system to, perform the steps of detecting, at a multimedia gateway connected to the home devices, a change in the first home device; sending, from the gateway to a home device configuration recommender, data indicative of the change; requesting and receiving, at the home device configuration recommender and from a home device capability database, data representing capabilities of the home devices; comparing, at the home device configuration recommender, the data representing capabilities with the data indicative of the change, for determining a suitable configuration recommendation for the first home device; and sending, from the home device configuration recommender via the multimedia gateway to the first home device, data representing the suitable configuration recommendation.

The inventive system and computer readable medium may comprise, be configured to execute and/or having stored software instructions for performing any of the features described above in association with the inventive method, and has the corresponding advantages. For example, for the inventive system and computer readable medium, the data representing capabilities and the data indicative of the change each comprise a formal representation of a set of features of the associated home device, for providing the suitable configuration recommendation based on a performance impact of the change on the capabilities of the home devices.

### BRIEF DESCRIPTION OF THE DRAWINGS

Embodiments of the invention will now be described, by way of example, with reference to the accompanying schematic drawings, in which

FIG. 1 illustrates the inventive system and steps to be taken for creating a database with capabilities of home devices,

FIG. 2 illustrates the system of FIG. 1, but with steps to be taken for implementing an embodiment of the invention, and

FIG. 3 is a flow diagram for discovering a home device having capabilities, and

FIG. 4 is a flow diagram of the inventive method.

### DETAILED DESCRIPTION OF PREFERRED EMBODIMENTS

In general, an embodiment of the method and system for providing a configuration recommendation for a home device, or user equipment, involves a home network environment that includes the IP Multimedia Subsystem (IMS) and a multimedia gateway in the form of a home IMS gateway (HIGA) which is being the interface to the home network of a consumer. The IP Multimedia Subsystem, home IMS gateway and other relevant part of the system are configured according to the IP Multimedia Subsystem (IMS) architectural framework for delivering Internet protocol (IP) multimedia services, as designed by the wireless standards body 3rd Generation Partnership Project (3GPP).

It should be noted, as further described below, that the home device configuration recommender preferably does not actually manage the installed devices, or features which may Include software applications, but instead provides recommendations for configurations, which are to be applied by any existing provisioning or management entity. However, the home device configuration recommender may be configured to use the configuration recommendation for updating or setting configuration values in a home device.

Preferably and for more efficient implementation, the devices, which constitute both hardware and software components of the home network, can be managed either directly or through a control system. Moreover, the hardware and software devices are each described in a format which allows for machine reasoning, such as in a format specified by the Resource Description Framework (RDF) which is a family of World Wide Web Consortium (W3C) specifications, or specified by the Protocol for Web Description Resources (POWDER) which is a working draft created by W3C that specifies a protocol for publishing metadata about Web resources using e.g. RDF, Web Ontology Language (OWL), and HTTP.

Finally authentication and authorization is done using the IMS system and the home network has a control point; the home IMS gateway which is used to interface the unmanaged home network with a control system of the managed network (IMS).

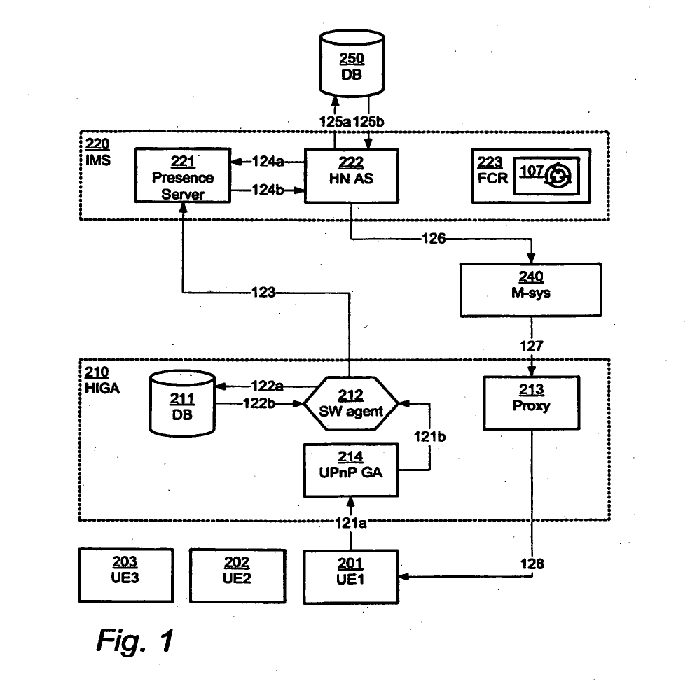

In further detail and with reference to FIG. 1, an embodiment of a computer system providing a configuration recommendation comprises the home IMS gateway 210 and the IMS system 220 to which the home IMS gateway 210 is connected. The home IMS gateway 210 includes a device database (DB) 211 for storing information, a Universal Plug and Play gateway (UPnP GA) 214, a software agent (SW agent) 212 that is executed on a processor (not shown) of the home IMS gateway 210, and a software implemented proxy server 213 also being executed on the same processor. More specifically, the software agent is a presence agent that detects presence (at the gateway 210) of a home device. The UPnP gateway 214 includes a so called Universal Plug and Play (UPnP) Control Point as specified by the UPnP Forum, and stores in the device database 211 various parameters related of the discovery or change of a home device. Three exemplifying home devices (UE1, UE2, UE3) 201, 202, 203 are included and arranged to be connected to and communicate with the home IMS gateway 210.

The IMS system 220 comprises a presence server 221, a home network application server (HN AS) 222 and a feature configuration recommender (FCR) 223, or more specifically a device configuration recommender. The components of the IMS system 220 are mutually connected and communicate with each other, either directly or via other components of the IMS system 220.

In this embodiment, a management system (M-sys) 240 is arranged for e.g. receiving data from the IMS system and to use this data for controlling, via the proxy 213 in the home IMS gateway 210, a user device 201 connected to the home IMS gateway 210.

The home network is typically a residential local area network, and is used to connect multiple home devices within the home and is typically used for providing e.g. triple play services (voice, video and data) to a user. The home IMS gateway may bear services of different types at the same time. Including differentiating service streams in complicated networking and scheduling services of different priorities (DSL, Bluetooth, Ethernet, HSPA, power line communication, USB and WI-Fi at the same time). The home IMS gateway also supports support remote control, detection and configuration of the home devices that are connected to the gateway.

As known within the art, the IMS system is an architectural framework for delivering Internet protocol (IP) multimedia services and uses Internet protocols such as the Session Initiation Protocol (SIP). As the system is an IMS system, it aids the access of multimedia and voice applications across wireless and wireline terminals. This is done by having a horizontal control layer that isolates an access network from a service layer. Services need not have their own control functions, as the control layer is a common horizontal layer.

The user can connect to the IMS system (network) in various ways, all of which use the standard Internet Protocol. Direct IMS terminals such as cell phones, PDAs and computers can register directly on the IMS network if they use e.g. IPve and run Session Initiation Protocol (SIP) user agents. Phone systems like traditional analogue telephones, H.323 and non IMS-compatible VoIP systems are supported through gateways.

Of course, the IMS system also includes a home subscriber server which is a master user database that supports the IMS network entities that actually handle calls. It contains Information related to user profiles, performs authentication and authorization of the user and can provide information about the user's physical location.

The home network application server host and execute services and interface with a central node of the signaling plane of the IMS system that is located in the home network for downloading and uploading user profiles. Since this node has no local storage of the user, all necessary information is loaded from the home subscriber server. Depending on the service, the application server can operate in SIP proxy mode, SIP user agent mode or SIP back-to-back user agent mode. The application server may be located in the home network or in an external third-party network. If located in the home network, it can query the home subscriber server with e.g. the known Diameter Sh interface or the Mobile Application Part interface.

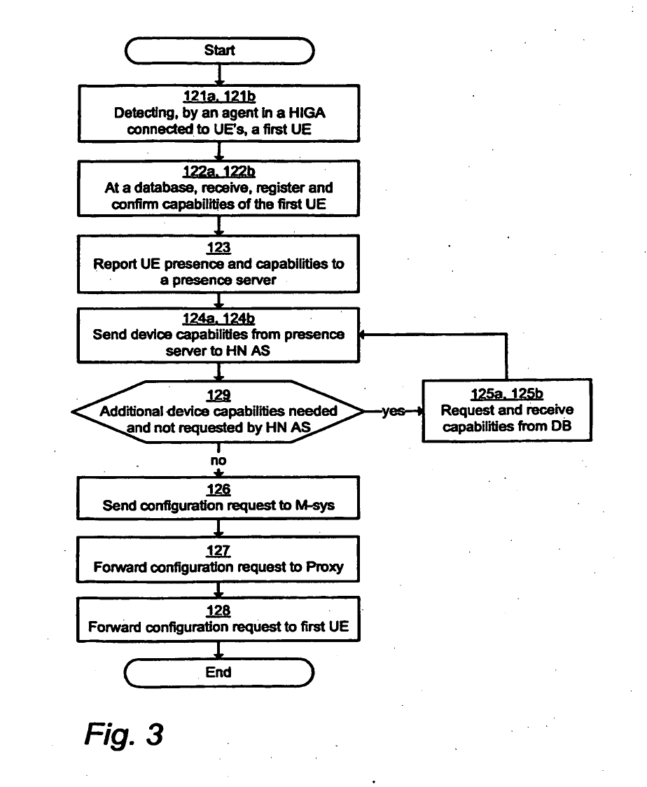

Turning again to FIG. 1 and with further reference to FIG. 3, steps are illustrated for discovering a device 201 that is connected, and discover the description of the device 201.

First the device 201 is discovered 121a by the UPnP gateway 214 which communicates 121b to the presence agent 212 the discovery of the device 201. Next the presence agent 212 sends 122a a message with device information to the device database 211 which in turn registers the capabilities of the device 201 and sends 122b a confirmation message to the presence agent 212, which accordingly has information pertaining to the capabilities and the presence of the device 210. Optionally, the UPnP gateway 214 communicates with the device database 211 instead of the presence agent 212.

Next the presence agent reports 123 the presence and the capabilities to the presence server 221 which notifies the home network application server 222. At this point, the home network application server 222 can receive from the presence server 221 the device capabilities, if this should this be required and requested by the home network application server 222. If required, e.g. if information about the device capabilities is needed, the home network application server 222 queries 124a the presence server 221 for the device capabilities. This query can also be the result of a trigger, such as the notification by the presence server 221, or it can be triggered by some other action such as a media server requesting device capabilities.

Thereafter a reply is returned 124b to the home network application server 222. If, for example, the device 201 is manageable du to an implementation of DSL Forum TR-069 or similar protocols, the home network application server 222 can send a configuration message to the presence server 221, which also will contain a configuration request, which in practice includes a confirmation of the created configuration of the device 201. This is additional to the request for capabilities in the step 123. Since the device information is retrieved from the device 201, and updated when the configuration of the device 201 changes, the information represents the device and the configurability can be assumed to cover the device 201. If a data model according to DSL Forum TR-069 does not cover the connected device 201, a data model can either be automatically extended provided there is a structured description of the device 201, or, if a need therefore is determined 129 by the home network application server 222, a description may requested 125a and downloaded 125b from a canonical namespace which is a container providing rule based context for various devices it holds.

After this a configuration request is sent to the device 201, which in this example is done 126 via a management system 240 capable of configuring the device 201. The management system sends 127 the request to the proxy 213 in the home IMS gateway 210 and the request is then forwarded 128 by the proxy to 213 the device 201.

Finally, a confirmation of the configuration request may be returned from the device 201 to the home network application server 222.

Hence, by performing the steps above, a database of devices present in the network may be constructed in the home network application server 222.

The capabilities sent 123 to the presence server 221 may be sent in any applicable format, such as a format specified by the known Service Description Protocol (SDP), the User Agent Profile (UAProf) specification, the Wireless Universal Resource File (WURFL), DSL Forum TR-069, or any other format which follows a structured model (i.e. is published according to a schema, such as an XML schema), i.e. the capabilities are returned from the configured devices in their native format, embedded in the presence document. This implies that the capabilities collection can be much richer than the presently used means for collecting device capabilities using presence.

If the device 210 does not support an application layer protocol for remote management of user devices, such as TR-069, but there are still possibilities to manage the device, the management can be done by the proxy 213 in the home IMS gateway 210. The proxy 213 can either communicate with the device 201, acting as a control point and reconfiguring the device 201, or it can act as a proxy and provide filtering for the device.

When the home network application server 222 gets a notification of a registered device, it is probable that not all the capabilities which are useful in determining how to avoid conflicts and feature interactions are available for the home network application server 222. For this reason, devices should regularly be queried for detailed capabilities, so the capabilities continuously may be updated.

When the home network application server 222 has a description of devices in the home network, the device configuration recommender 223 use this to automatically conclude what possible combinations of the devices and software of the devices that may cause problems if interacting in undesirable ways, and provide a way of rectifying the problems. The device configuration recommender 223 can use the retrieved capabilities from the home network application server 222 to model the home network and analyze whether there will be any feature interaction issues, for subsequently providing configuration recommendations for home devices.

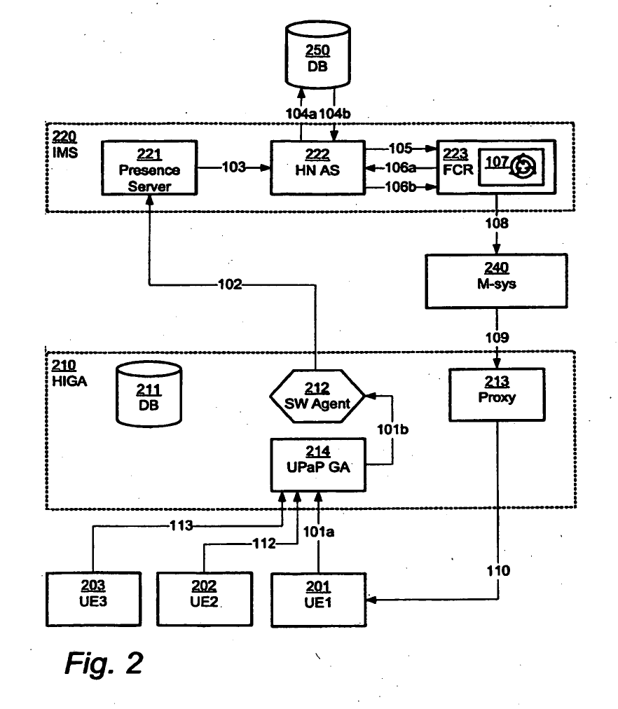

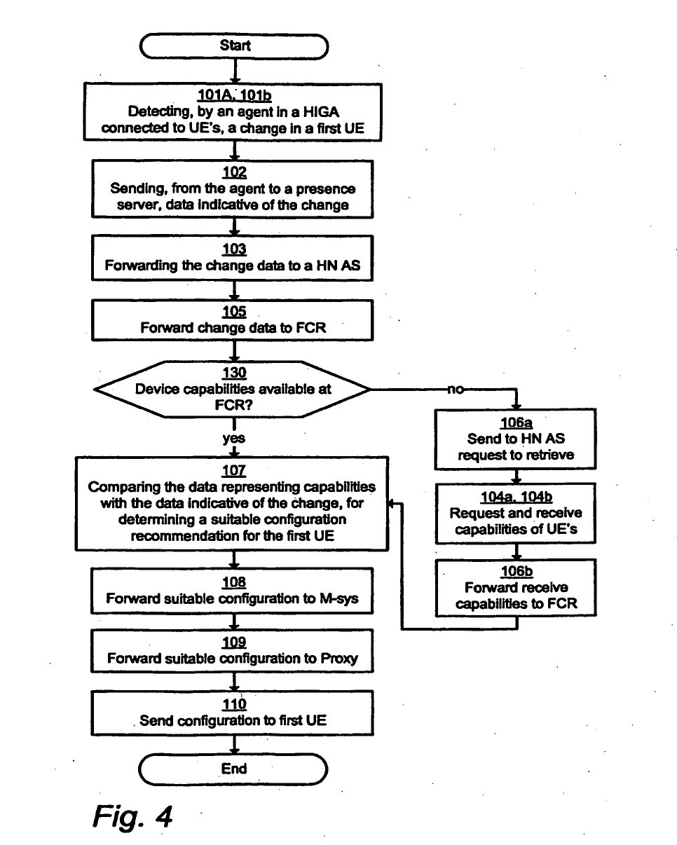

With reference to FIG. 2 and FIG. 4, steps are illustrated for providing such feature recommendation for a first home device 201 of a plurality of home devices 201, 202, 203 that are connected to the home IMS gateway 210.

First 101a a change in the home device 201, which change may be e.g. an addition of other devices such as screens which can be utilized by the device, software upgrades of the device or state changes of the device, triggers a request to receive recommendations for configuration. The request is sent to or detected by the Universal Plug and Play gateway 214 which forwards 101b the request to the presence agent 212. These steps can be done over any prevailing network in a home, and any applications'protocol which allows for sending events may be used, including direct connection protocols such as the Internet Cache Protocol (ICP), the Web bases CEA-2014-A protocol, the network protocol Remote Procedure Call (RPC) or by implementing e.g. the General Event Notification Architecture (GENA).

Since the detection of the home device is first done by the UPnP gateway and is then forwarded to the presence agent, it may be said that the device is detected by the presence agent. However, since the UPnP gateway, which is a typical, suitable UPnP gateway as known within the art, also comprises a software agent the device is always detected by a software agent.

Next 102 the presence agent 212 forwards the change to the presence server 221. Depending on any filtering rules implemented in the presence agent 212 and the presence server 221, this may be done instantly, or at a different time, such as when 10 different changes are aggregated, or after 10 minutes from a first change. The setting and management of filtering rules is done according to known technology which is typically standardized.

Thereafter 103 the presence server 221 sends a notification to the home network application server 222, including or referencing a service discovery protocol containing the device capability schema or include a link to a UAProf-file that is specified by the User Agent Profile (UAProf) specification. The home network application server 222, since it in this embodiment is an IMS application server, will have an IMS Service Control interface, which can be used to communicate events either over the SIP NOTIFY or SIP MESSAGE methods, or using the Diameter Sh interface.

Then 104a, 104b the home network application server 222 retrieves metadata for the capabilities of the connected home devices 201, 202, 203. This is done out of band from the retrieval of the capabilities, e.g. through a HTTP GET to a canonical server (database) 250 in the namespace of the capabilities description. This step can be completed at any time and does not have to be triggered by the reception of the device characteristics even though this maybe would be the most typical case. Note that the purpose of the configuration process can be set in the home network application server 222, either directly by the operator or by the home user. Moreover, the database 250 with the description service mentioned here can be the equivalent of a centralized database of 3:rd party descriptions e.g. by using the known Wireless Universal Resource File, or it can be the vendor specific capability descriptions. In brief; to receive capability and configurations information for home devices, a request is sent 104a to retrieve of the capabilities metadata and a response with the capabilities or configurations descriptions is returned 104b.

Next 105 the home network application server 222 sends a notification of the change and the device capabilities to the device configuration recommender 223 that shall provide an appropriate configuration for the occurring event.

If it is determined 130 by the device configuration recommender 223 that characterizations of the devices are not already available, the device configuration recommender 223 can now download the characterizations of the devices which are applicable to calculate the appropriate device configuration. This is done by the device configuration recommender 223 requesting 106a the device capability information from the home network application server 222, and then the device configuration recommender 223 receives 106b the capabilities from the home network application server 222.

Then 107 the appropriate recommendations are computed by the device configuration recommender 223, which is described in further detail below. However, computing recommendations per se is known within the art and any suitable method may be used, taking various types of devices and types of capabilities into account.

Thereafter 108 the computed recommendation is sent to the management system (server) 240 for It to upload the configuration appropriately, which includes first 109 uploading the configuration to the proxy 213, which may be a HTTP proxy, and then uploading 110 the configuration to the device 201 itself.

Appropriate recommendations are computed by the device configuration recommender by, for example, implementing the steps below which are only generally described as computations of recommendations are device dependant and suitable known methods should typically be used.

First, it is determined if the device capability descriptions are available in a machine-understandable format, such as in a formal ontology format like the Web Ontology Language (OWL) which is a specification or recommendation issued by the World Wide Web Consortium (W3C).

If the capability descriptions are not available in a machine-understandable format, descriptions are retrieved and normalized to such a format, e.g. by mapping it to the Resource Description Framework (RDF) specification, which also is Issued by the World Wide Web Consortium, and by mapping a RDF metadata data model to a formal ontology.

Next, when the capability descriptions are available as formal ontology descriptions, the device configuration recommender uses these to draw conclusions about the optimal configuration for how the capabilities described will interact. In case it is determined that there is no risk that the capabilities interact with each other, such as when relevant devices does not use any common resource of the network, nothing is done. Detection of interaction can be performed at any time there is an update of the presence of a device, i.e. when a device is connected to or removed from the network, taking into account that the addition of new capabilities and/or devices may add risks for feature interactions. Of course, interaction may be determined as a part of the process of determining a configuration recommendation.

Thereafter, if devices will interact, recommendation as derived or derived in full in case interaction is part of the deriving of recommendation. This includes the possibility to continuously model the device interactions, which can be used to proactively remedy them. In this case, the modeling itself can trigger an update of a management document that hold configuration information for configuring the relevant device. The modeling of configuration can be performed by deriving an ideal model (device interaction pattern) for how devices should interact to provide a relatively improved service for a user without one device or service associated with a device blocking another one or hampering performance. To achieve this a target configuration is set and the resulting interaction pattern is compared with pre-defined interaction patterns. The target configuration use the ideal feature interaction pattern in a fitness function in a mutation process to generate a better feature interaction model from the stored ones. The fitness check is iteratively repeated until the configuration that yields the best performance is found. This would of course allow for implementation of various optimization techniques.

To elucidate the triggering of the device configuration recommender, a potential method for triggering the device configuration recommender is based on measurements passing threshold values. These measurements can be derived using a probe inserted in the residential network, and a possible insert location for the probe is the residential gateway. If the residential gateway is co-located with a services gateway, it makes it even more feasible as deployment location. This node, which here is the home IMS gateway, can either have a probe which is pre-installed, or the probe installation itself can be triggered by a series of events which are measured by the management system of a network to which the home network is connected. This would imply that in an IMS network, when the *-CSCF measures sudden changes or variations in signaling from the residential network, an installation of a probe into the home network would be signaled.

The probe results can be aggregated using presence. If the result is reported as part of the presence document from the presence agent in the home IMS gateway, multiple presence agent results can be aggregated by the home network application server. If they are aggregated, the results can be used also for other purposes than the computation of an optimal configuration, for instance offering the results for sale to manufacturers of consumer electronics equipment, who can use them to optimize their equipment.

Another way to apply the probe results is to collate the results from multiple probes and determine whether the result diverges from the mean or median, or some other measurement. The determination of the probe group which is the base for the measurement can be based on proximity, of similarity of configuration, or some other means. The group management in the presence system can be used to manage this group.

When the home network application server has a complete description of the devices in the home network, the feature configuration recommender can use this to automatically conclude what possible combinations of devices and software may cause problems by interacting in undesirable ways, and rectify these. The feature configuration recommender can use the retrieved capabilities from the home network application server to model the home network and analyze whether there will be any feature interaction issues.

The feature configuration recommender can be triggered to provide its recommendations in a number of ways, and by a number of interacting entities, e.g. by i) by a probe in the home network detecting feature interactions, ii) by the home network application server discovering possibilities of feature interactions, iii) by a management system or an entity in the control system (such as the *CSCF in IMS) discovering either feature interactions, or feature interaction possibilities, iv) by traffic conditions as measured by either the “CSCF, or by a probe in the home network, or v) by a timer.

The feature configuration recommender, when triggered, will create a list of optimal configurations, which are to be implemented by the appropriate management systems. Various systems include OMA DM, UPnP ExEPF, TR-069, SNMP traps, or a number of other configuration or provisioning systems.

In other words and briefly, when the home network application server gets a notification of a registered device, it is probable that not all the capabilities which are useful in determining how to avoid conflicts and feature interactions are available. For this reason, the system should query the device for its detailed capabilities, and get continuous updates about the capabilities.

The system does so by querying the home IMS gateway database for additional capabilities, which were not reported using presence. In addition, protocol-specific queries may be done using a proxy in the home IMS gateway, which is triggered by the request for additional device capabilities from the presence server (which came from the home network application server). The descriptions are delivered using presence in a format that allows for automatic machine reasoning.

In addition to the information retrieved from the home devices, the home network application server can get information and notifications from the home IMS gateway. The notifications and information can be retrieved from proxies and registrars included in or connected to the home IMS gateway, for instance HTTP proxies and SIP registrars, which will be able to derive information about what services have been used in the residential network.

When the database of devices and capabilities are collected by the home network application server they can be used by the device configuration recommender. The recommender coordinates the installation and management of software, and has a database accessible by a rules-controlled system, which can draw autonomous conclusions about the reason for problems in the operations of the system and their causes, based on the previous experiences, configuration information, and other available information.

In addition to the manageability, this can be used to configure the systems to optimize the performance of the residential network, as well as the performance of the residential network over the remote network. This will essentially be performed in the same way as described, but in addition to the devices inside the home, the residential gateway may also be configurable, the settings of the gateway reflecting the configuration of the residential net and the services which are requested. This process can be repeated when there is a request for new services, which will either trigger the installation of new services, or a different configuration which is more optimal for the selected set of services.

As an alternative to the embodiment described above, it is possible to arrange the home network application server, or parts of it, in the home IMS gateway. It is also possible to implement the principles for providing configuration recommendations in another system than in an IMS system. Then, for example, if it is a server which interacts with the home network application server, the interactions of the system can be performed by using a specially designed HTTP/SOAP interface.

Although various embodiments of the invention have been described and shown, the invention is not restricted thereto, but may also be embodied in other ways within the scope of the subject-matter defined in the following claims.

1-19. (canceled)

20. A for providing a configuration recommendation to a first home device of a plurality of home devices in a home network, the method comprising the steps of:
detecting, at a multimedia gateway connected to the home devices, a change in the first home device,
sending, from the gateway to a home device con-figuration recommender, data indicative of the change,
requesting and receiving, at the home device configuration recommender and from a home device capability database, data representing capabilities of the home devices,
comparing, at the home device configuration recommender, the data representing capabilities with the data indicative of the change, for determining a suitable configuration recommendation for the first home device, and
sending, from the home device configuration recommender via the multimedia gateway to the first home device, data representing the suitable configuration recommendation.

21. A method according to claim 20, wherein the step of sending the data indicative of the change comprises sending this data via a presence agent and a presence server.

22. A method according to claim 20, wherein the step of sending the data indicative of the change comprises sending this data via a home network application server.

23. A method according to claim 22, comprising the step of retrieving, from a database and by the home network application server, data representing capabilities of the home devices.

24. A method according to claim 23, wherein the step of retrieving data representing capabilities of the home devices is initiated by a request sent from the home device configuration recommender to the home network application server.

25. A method according to claim 20, wherein the step of sending data representing the suitable configuration recommendation comprises sending this data via a device management server and a proxy server of the multimedia gateway.

26. A method according to claim 20, wherein the data indicative of the change and the data indicative of the suitable configuration recommendation are sent as Session Initiation Protocol (SIP) messages.

27. A method according to claim 20, wherein the multi-media gateway is a home IMS gateway and the home network is an IMS network.

28. A method according to claim 20, wherein the data representing capabilities and the data indicative of the change each comprises a formal representation of a set of features of the associated home device, for providing the suitable configuration recommendation based on a performance impact of the change on the capabilities of the home devices.

29. A computer system for providing a configuration recommendation to a first home device of a plurality of home devices in a home network, the system being configured to:
detect, at a multimedia gateway connected to the home devices, a change in the first home device,
send, from the gateway to a home device configuration recommender, data indicative of the change,
request and receive, at the home device configuration recommender and from a home device capability database, data representing capabilities of the home devices,
compare, at the home device configuration recommender, the data representing capabilities with the data indicative of the change, for determining a suitable configuration recommendation for the first home device, and
send, from the home device configuration recommender via the multimedia gateway to the first home device, data representing the suitable configuration recommendation.

30. A system according to claim 29, wherein the sending of data indicative of the change comprises sending this data via a presence agent and a presence server.

31. A system according to claim 29, wherein the sending of data indicative of the change comprises sending this data via a home network application server.

32. A system according to claim 31, configured to retrieve, from a database and by the home network application server, data representing capabilities of the home devices.

33. A system according to claim 32, wherein the retrieving of data representing capabilities of the home devices is initiated by a request sent from the home device configuration recommender to the home network application server.

34. A system according to claim 29, wherein the sending of data representing the suitable configuration recommendation comprises sending this data via a device management server and a proxy server of the multimedia gateway.

35. A system according to claim 29, wherein the data indicative of the change and the data indicative of the suitable configuration recommendation are sent as Session Initiation Protocol (SIP) messages.

36. A system according to claim 29, wherein the multimedia gateway is a home IMS gateway and the home network is an IMS network.

37. A system according to claim 29, wherein the data representing capabilities and the data indicative of the change each comprises a formal representation of a set of features of the associated home device, for providing the suitable configuration recommendation based on a performance impact of the change on the capabilities of the home devices.

38. A computer readable medium having stored thereon a computer program having software instructions which when run in a computer system cause the system to, perform the steps of:
detecting, at a multimedia gateway connected to the home devices, a change in the first home device,
sending, from the gateway to a home device configuration recommender, data indicative of the change,
requesting and receiving, at the home device configuration recommender and from a home device capability database, data representing capabilities of the home devices,
comparing, at the home device configuration recommender, the data representing capabilities with the data indicative of the change, for determining a suitable configuration recommendation for the first home device, and
sending, from the home device configuration recommender via the multimedia gateway to the first home device, data representing the suitable configuration recommendation.
